(19) United States
(12) Patent Application Publication
(10) Pub. No.: US 2017/0270195 A1
(43) Pub. Date: Sep. 21, 2017

(54) PROVIDING TOKEN-BASED CLASSIFICATION OF DEVICE INFORMATION

(71) Applicant: Nokia Technologies Oy, Espoo (FI)

(72) Inventors: Ning ZHANG, Beijing (CN); Mei DONG, Beijing (CN)

(21) Appl. No.: 15/612,748

(22) Filed: Jun. 2, 2017

Related U.S. Application Data
(63) Continuation of application No. 13/993,977, filed on Jun. 13, 2013, now abandoned.

(51) Int. Cl. G06F 17/30; G06Q 30/02

(52) U.S. Cl. CPC G06F 17/30705; G06Q 30/0255

(57) ABSTRACT

An approach is provided for providing token-based classification of device information. A token management platform determines a plurality of tokens. The tokens include at least in part one or more keywords, one or more representative media items, or a combination thereof. The token management platform processes and/or facilitates a processing of a communication history, one or more personal information sources, or a combination thereof associated with a user to determine one or more frequency counts of respective one or more of the tokens. The token management platform then determines to cause, at least in part, a generation of recommendation information based, at least in part, on the one or more frequency counts of the respective one or more tokens.

### CROSS REFERENCE TO RELATED APPLICATIONS

This application is a continuation U.S. patent application Ser. No. 13/993,977, filed Jun. 13, 2013, and titled “Providing Token-Based Classification of Device Information”, which is a National Stage Entry of International Application No. PCT/CN10/80154, filed Dec. 23, 2010, titled “Method and Apparatus for Providing Token-Based Classification of Device Information”, the entireties of which are incorporated herein.

### BACKGROUND

Service providers and device manufacturers (e.g., wireless, cellular, etc.) are continually challenged to deliver value and convenience to consumers by, for example, providing compelling network services. Many of these services (e.g., communication services, multimedia services) generate data and/or other content that can quickly accumulate within a user device (e.g., a mobile phone, a smartphone, etc.). Moreover, much of this information is stored with little or no organization, thereby making it difficult for users to retrieve and make use of the data and/or content at a later time. Accordingly, service providers and device manufacturers face significant technical challenges to enabling users to organize, classify, and/or otherwise manage information accumulated at their devices (e.g., communication histories, multimedia collections, etc.).

### SOME EXAMPLE EMBODIMENTS

Therefore, there is a need for an approach for providing token-based (e.g., keyword-based, media token-based, etc.) classification of device information.

According to one embodiment, a method comprises determining a plurality of tokens. The tokens include at least in part one or more keywords, one or more representative media items, or a combination thereof. The method also comprises processing and/or facilitating a processing of a communication history, one or more personal information sources, or a combination thereof associated with a user to determine one or more frequency counts of respective one or more of the tokens. The method further comprises determining to cause, at least in part, a generation of recommendation information based, at least in part, on the one or more frequency counts of the respective one or more tokens.

According to another embodiment, an apparatus comprises at least one processor, and at least one memory including computer program code, the at least one memory and the computer program code configured to, with the at least one processor, cause, at least in part, the apparatus to determine a plurality of tokens. The tokens include at least in part one or more keywords, one or more representative media items, or a combination thereof. The apparatus is also caused to process and/or facilitate a processing of a communication history, one or more personal information sources, or a combination thereof associated with a user to determine one or more frequency counts of respective one or more of the tokens. The apparatus is further caused to determine to generate recommendation information based, at least in part, on the one or more frequency counts of the respective one or more tokens.

According to another embodiment, a computer-readable storage medium carries one or more sequences of one or more instructions which, when executed by one or more processors, cause, at least in part, an apparatus to determine a plurality of tokens. The tokens include at least in part one or more keywords, one or more representative media items, or a combination thereof. The apparatus is also caused to process and/or facilitate a processing of a communication history, one or more personal information sources, or a combination thereof associated with a user to determine one or more frequency counts of respective one or more of the tokens. The apparatus is further caused to determine to generate recommendation information based, at least in part, on the one or more frequency counts of the respective one or more tokens.

According to another embodiment, an apparatus comprises means for determining a plurality of tokens. The tokens include at least in part one or more keywords, one or more representative media items, or a combination thereof. The apparatus also comprises means for processing and/or facilitating a processing of a communication history, one or more personal information sources, or a combination thereof associated with a user to determine one or more frequency counts of respective one or more of the tokens. The apparatus further comprises means for determining to cause, at least in part, a generation of recommendation information based, at least in part, on the one or more frequency counts of the respective one or more tokens.

According to another embodiment, a method comprises facilitating access to at least one interface configured to allow access to at least one service, the at least one service configured to determine one or more contexts for at least one level of a hierarchy of one or more context parameters. The hierarchy reflecting different granularities of the one or more context parameters. The at least one service is also configured to determine to generate at least one rule set based, at least in part, on the one or more contexts. The at least one service is further configured to determine to include the at least one rule set in the hierarchy for generating recommendation information for one or more applications.

According to another embodiment, a computer program product including one or more sequences of one or more instructions which, when executed by one or more processors, cause an apparatus to determine one or more contexts for at least one level of a hierarchy of one or more context parameters. The hierarchy reflecting different granularities of the one or more context parameters. The apparatus is also caused to determine to generate at least one rule set based, at least in part, on the one or more contexts. The apparatus is further caused to determine to include the at least one rule set in the hierarchy for generating recommendation information for one or more applications

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-19, 40-58, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing token-based classification of device information, according to one embodiment;

FIG. 2 is a diagram of the components of a token management platform, according to one embodiment;

FIG. 3 is a diagram of data structure for storing tokens, according to one embodiment;

FIG. 4 is a flowchart of a process for initializing token-based classification of device information, according to one embodiment;

FIG. 5 is a flowchart of a process for generating recommendation information from token-based classification of device information, according to one embodiment;

FIG. 6 is a flowchart of a process for applying token-based classification to contact information, according to one embodiment;

FIG. 7 is a flowchart of a process for applying token-based classification to location data, according to one embodiment;

FIGS. 8A-8F are diagrams of user interfaces used in the processes of FIGS. 1-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing token-based classification of device information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

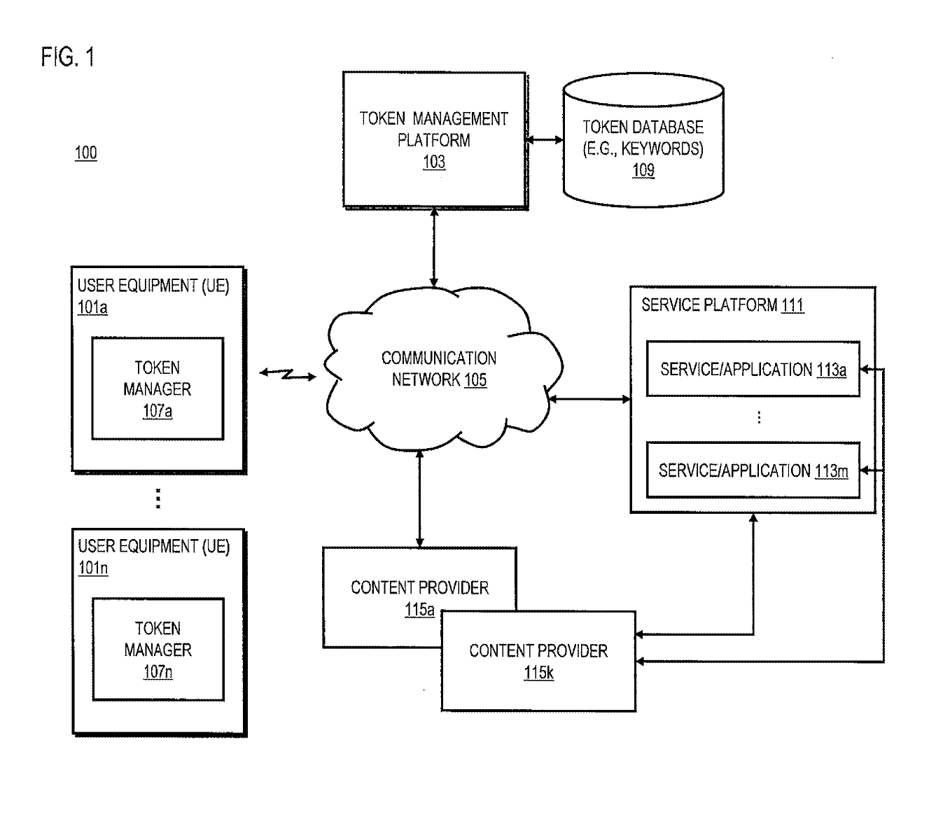

FIG. 1 is a diagram of a system capable of providing token-based classification of device information, according to one embodiment. The storage size of modern user devices (e.g., mobile devices such as cell phones and smartphones) are continuously increasing, thereby enabling users to store more personal information and other related information. At least some of this information may be vital to the end user. However, after a period of time, users traditionally have tended to “forget” about what has been previously stored, and much of the stored information can represent “dead end” information that takes space and provides no additional value to the user. In some cases, even searching for such information can pose a potentially significant time and/or resource burden on the user.

As a result, device information such as old message, pictures, and other media clips saved by the user over time are often not readily available to the user. In many cases, the user can be reluctant to delete the information for fear that the information may be helpful or otherwise useful at some point in the future. In this way, the memory resources (e.g., phone memory and/or storage memory) of a user's device would be consumed bit-by-bit over time by the unorganized information.

Without organization, much of the stored information become difficult and/or resource intensive to access. For example, in one scenario, a user wants to buy a gift for a friend, and has no idea about what the friend likes. The user has communication history (e.g., old messages, emails, etc.) stored on the user's device that are related to the friend, but has to manually search or read through all of the contact information associate with the friend, or view photos or videos of the friend to find hints about what gift to buy. This process can be time consuming. In another scenario, a user likes shopping and cares for everything about shopping. However, whenever the user wants to find some useful old or new information (e.g., favorite shops, recent purchases, etc.) about shopping that might be stored on the user's device, the user always has to manually search the device which may require a lot of steps and be quite time consuming.

To address this problem, a system 100 of FIG. 1 introduces the capability to automatically classify and index device information (e.g., communication histories, personal information databases, multimedia databases, application data, etc.) according to tokens that represent things, ideas, concepts, categories, etc. of potential interest to the user. As used herein, the term “tokens” refers to keywords, representative media items, or a combination thereof that describe, represent, or otherwise signify the things, ideas, concepts, categories, etc. of potential interest. In this embodiment, keywords are descriptive labels associated with the items of interest, and the representative media items representative media samples (e.g., images, sounds, etc.) of items of potential interests.

More specifically, the system 100 analyzes the device information to create a prioritized array of the tokens (e.g., keywords) based on the relative important and/or relevance of the keywords to the device information associated with a particular user. In one embodiment, the prioritized array is created by determining the frequency counts of tokens (e.g., determining how many times a keyword or a representative image appears in the device information). The tokens with the highest frequency counts are then given the highest priority or determined to be more closely associated with the user information.

In one embodiment, the frequency counts may be determined with respect to certain contexts and/or conditions. For example, the system 100 may determine the tokens and their respective frequency counts in association with specific contacts associated with the user. In this way, each of the user's contacts may be associated with a different priority of the tokens depending on their interaction history with the user. These tokens can, for instance, describe common interests between the user and the contact, a relationship between the user and the contact (e.g., family, coworker, etc.), a relationship state between the user and the contact (e.g., close friend, a mere acquaintance, etc.), one or more states of mind with respect to the contact (e.g., a mood with respect to contact such as “happy with the contact”, “mad at the contact”, etc.), or a combination thereof. In another embodiment, the user may a “My card” listing (e.g., the user's own contact card) independent of a specific contact, so that the user can browse all information related to the tokens conveniently.

In another use case, the system 100 may determine the tokens with respect to specific locations or places associated with the user. For example, the system 100 may determine location data associated with at least some of the device information (e.g., search history, photos of particular locations). This location data can then be associated with its own set of tokens to capture user specific interests with respect to the location. In yet another embodiment, the user specific tokens may be combined with tokens specific to other user to define community or group interests.

In one embodiment, the system 100 determines the set of tokens from a default or predetermined set of tokens. By way of example, the default set may be determined by a service provider, network operator, device manufacturer, etc. to reflect common interests. In addition or alternatively, the system 100 may perform a semantic analysis of the device information to discover the set of tokens to use for classifying the device information.

In yet another embodiment, the user can also define at least some of the tokens for classification, so that the system 100 can present the device information of the user is interested in directly. In some embodiments, the system 100 can provide some recommended tokens to help the user find information of interest. Moreover, the system 100 can recommend the deletion or modification of one or more of the tokens based on their occurrence or frequency counts in the device information.

In one embodiment, the system 100 can recommend or associate external modules and/or plugins based on the tokens. For example, the module and/or tokens may provide for presentation of advertising, marketing, and/or promotional materials based on the keywords associated with user, the user's contexts, and/or device information. It is contemplated that the device information can include information for applications executing at the device, internet browsing history, communication histories, and any other information stored at or otherwise associated with the device.

As shown in FIG. 1, the system 100 comprises a user equipment (UE) 101 or multiple UEs 101a-101n (or UEs 101) having connectivity to a token management platform 103 via a communication network 105. A UE 101 may include or have access to a token manager (e.g., token managers 107a-107n), which may consist of client programs, services, or the like that may utilize a system to provide token-based classification of device information to users. In one embodiment, the token manager 107 can perform all or a portion of the processes of the token management platform 103. Moreover, the token management platform 103 and the token manager 107 may operate cooperatively and/or independently of each other. In one embodiment the token management platform 103 may include or be connected to a token database 109 for storing tokens (e.g., keywords, representative media items, etc.) used in the various embodiments described herein.

In one embodiment, when the system 100 is first activated (e.g., the token manager 107 is installed or activated at the UE 101), the system 100 scans all or substantially all of the information stored in the phone (e.g., communication history, application data, personal information databases, multimedia databases, etc.), to classify and index the device information based on a set of determined tokens (e.g., keywords). In one embodiment, the tokens are activated or used for classification of each information format used in the UE 101. By way of example, incoming information format includes, for instance: (1) text messages, instant messages, email message, and the like delivered to the UE 101 over the communication network 105; (2) pictures/documents delivered to the device (e.g., via short range wireless communications such as Bluetooth, WiFi, etc.); and the like. In some embodiments, the token-based classification may be further grouped or determined according to context information (e.g., location information such as country, region, etc.) where each different category of context information can have a separate set of tokens.

As discussed above, in one embodiment, the user can add, delete, and/or modify the set of tokens to customize the classification of the device information. Moreover, the user can associate one or more of the tokens with specific contacts to classify and index on a per contact basis. It is contemplated that the user and/or the token management platform 103 may define a set of tokens based on any criteria of the device information such as associated applications, associated types of communications, temporal associations, etc.

In one embodiment, the token management platform 103 and/or the token manager 107 can analyze user interactions and incoming information to dynamically update the token database in substantially real-time. In yet another embodiment, the token management platform 103 can organize the tokens into a hierarchy of categories and subcategories. In this way, the token management platform 103 can expand or collapse classified or categorized device information dynamically by the tokens for easier access and/or manipulation.

In yet another embodiment, the token management platform 103 can generate recommendation information (e.g., suggestions and/or recommendations) for use by one or more applications, services, processes, etc. executing at the UE 101 based, at least in part, on the frequency counts and/or prioritized order of the tokens. For example, the token management platform 103 can determine the token set or a priority of the tokens that is most associated with a particular application and the device information stored at the UE 101. The token set and/or priority then represents the tokens of most interest to the user with respect to the applications. The most relevant tokens can then be used to generate the recommendation information. In some embodiments, the applications and/or related tokens may be associated with external modules and/or plugins that provide additional functionality based on the associated and/or most relevant tokens. For example, the external modules and/or plugins may provide recommended or related advertisements, marketing information, promotions, etc. based on the associated tokens.

As shown, the UEs 101 and the token management platform 103 also have connectivity to a service platform 111 hosting one or more respective services/applications 113a-113m (also collectively referred to as services/applications 113), and content providers 115a-115k (also collectively referred to as content providers 115). In one embodiment, the service platform 111, the services/applications 113a-113m, the token manager 107a-107n, or a combination thereof have access to, provide, deliver, etc. one or more items associated with the content providers 115a-115k. In other words, content and/or items are delivered from the content providers 115a-115k to the applications 107a-107n or the UEs 101 through the service platform 111 and/or the services/applications 113a-113n. The service platform 111, services/applications 113, and/or the content providers 115 may deliver their functionality to the UE 101 based on the determined tokens associated with the UE 101 and/or a user of the UE 101. In addition, the service platform 111, services/applications 113, and/or the content providers 115 may also provide external modules and/or plugins (e.g., advertisement plugins, location-based services, etc.) to extend the functionality of the UE 101 based on the determined tokens.

In some cases, a service/application 113 and/or content provider 115 may request that the token management platform 103 generate one or more recommendations with respect to content, items, functions, services, etc. to deliver to the UE 101. After receiving the request for recommendation information, the token management platform 103 may then retrieve the tokens, token hierarchy, contexts, location, etc. from one or more profiles associated with the requesting service/application 113 and/or content provider 115. The token management platform 103 may further generate the content recommendation based at least in part on the retrieved token sets, prioritization of the tokens, token frequency count, etc. Because the recommendation information may be derived from a common set of tokens, the prioritized token set or frequency counts can be applicable to any number of the services/applications 113 and/or one content providers 115.

For example, using the system 100, a user who wants to buy a gift for a friend can just add or have the token management platform 103 determine relevant tokens associated with the friend's contact information at the device. More specifically, the relevant tokens can indicate potential interests of the friend based on prior communications that have been classified and index.

In a second example where the user has a great interest in all things related to shopping, the system 100 can define at least one shopping related token or keyword (e.g., “Shopping”). The system can then classify and index device information (e.g., search histories, personal databases, pictures, videos, etc.) based on the “Shopping” token. The user can then access a user interface of the UE 101 to select the token and then be presented with the corresponding indexed information and/or recommendations based on the token or indexed information. In addition, the system 100 can present advertisements or promotions associated with the token and/or indexed information to the user for review and selection.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the token management platform 103, and the token manager 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the token manager 107 and the token management platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

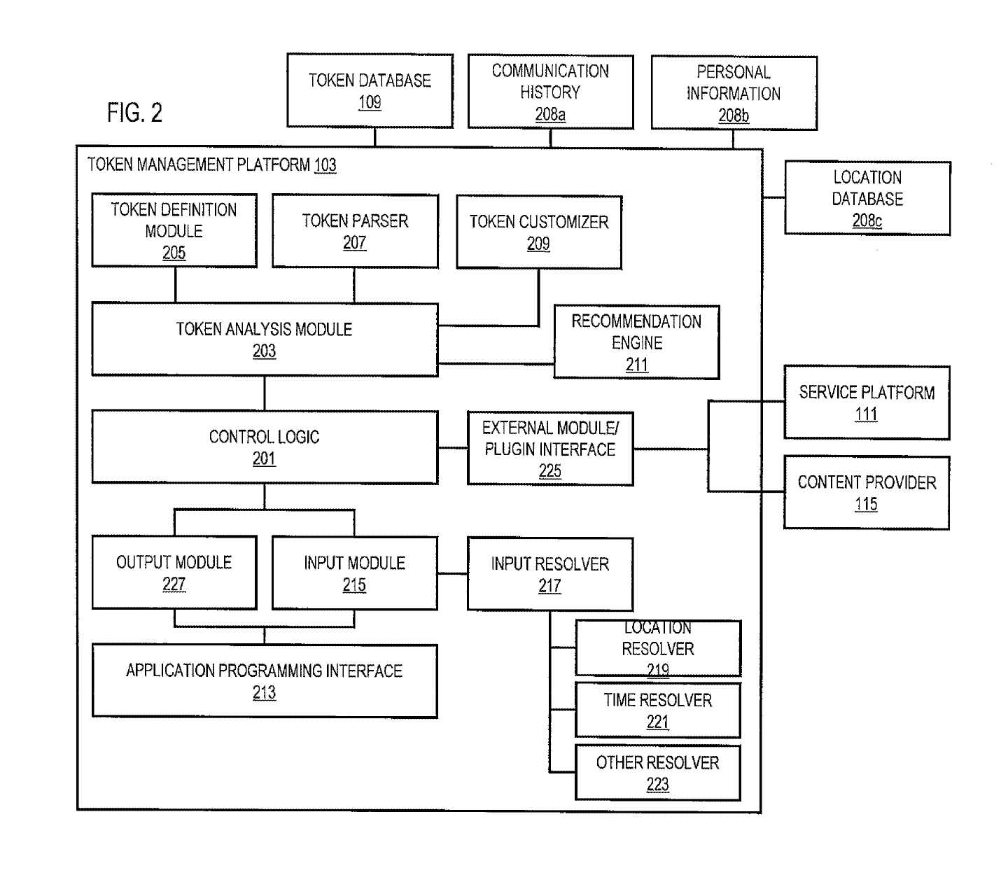

FIG. 2 is a diagram of the components of a token management platform, according to one embodiment. By way of example, the token management platform 103 includes one or more components for providing token-based classification of device information. It is contemplated that the functions of these components may be combined in one or more components or performed by other components of equivalent functionality. In this embodiment, the token management platform 103 includes at least a control logic 201 which executes at least one algorithm for performing and/or coordinating the functions of the token management platform 103. In one embodiment, the functions of the control logic 201 interacts with the token analysis module 203 to enable the user to classify and index previously stored and/or incoming device information based, at least in part, on one or more determined tokens. The indexed information can then be retrieved by selecting the corresponding token.

In one embodiment, the token analysis module 203 directs the token definition module 205 to create a set of one or more tokens for classifying device information. By way of example, the tokens include, at least in part, one or more keywords, one or more representative media items, or a combination thereof. In one embodiment, the tokens are defined from a pre-determined set of tokens that are representative of common categories, interests, items, etc. that are typical of group or community of users. For example, tokens that are keywords can describe common categories such as “shopping”, “sports”, “activities”, etc. Similarly, tokens that are representative media items (e.g., images) can be pictures of items, landmarks, locations, people, etc. of potential interest to the user.

In another embodiment, the token definition module 205 can build a token set based on manual input, thereby enabling, for instance, a service provider, network operator, and the like to provide input to write and/or build the token sets. In one embodiment, the token definition module 205 can formulate one or more token sets that correlate a context or context type (e.g., location, time, activity, etc.) with one or more language tokens or tags. By way of example, in one embodiment, users can contribute to the token sets by specifying one or more of the tokens from which the token sets are built. The users may also personalize the token sets by specifying particular tokens and/or contexts of interests (e.g., places of interests, favorite or common activities, etc.) for inclusion in the token sets. In another embodiment, the user can manually specify one or more of the tokens, contexts, etc. and related token creation rules. Then the token definition module 205 can automatically infer additional tokens from the token creation rules and/or the manual input. In yet another embodiment, a user can exchange tokens with other users directly via the user's UE 101 or via server or other service which can be established by, for instance, the token management platform 103, a content provider 115a-115k, etc.

The token definition module 205 can also interact with the token parser 207 to analyze the various sources of device information to semantically determine the tokens. In one embodiment, to generate the language tokens, tags, or keywords, the token parser 207 identifies or determines a set of device information associated with a particular user (e.g., communication history 208a, personal information database 208b (e.g., contact lists, media collection, etc.), location database 208c (e.g., landmarks or places of potential interest to the user). In one embodiment, to perform a semantic analysis of the device information, the token parser 207 then creates a language model that describes the most prevalent or main words or terms that appear in each device information sources. By way of example, for the device information to be analyzed, text or other information is extracted as language tokens or tags (e.g., each language token represents a word or phrase). For instance, each of the device information sources is crawled and parsed to obtain text. Since the text data are largely unstructured and can comprise tens of thousands of words, automated topic modeling can be used for locating and extracting language tokens from the text. In one embodiment, the token parser 201 extracts the noun tokens, and then performs a histogram cut to extract the least common nouns. To extract the noun tokens, the token parser 201 can deploy a part-of-speech tagging (POST) to mark up nouns in the text. By way of example, POST is a process of marking up nouns in a text (corpus) as corresponding to a particular part of speech, based on both its definition, as well as its context. Part-of-speech tagging is more than just having a list of words and their parts of speech, because some words can represent more than one part of speech at different times. For example, “dogs” is usually a plural noun, but can be a verb. The token parser 201 then extracts nouns using a language dictionary, and stores the noun tokens as a token set for storage in the token database 109.

The token set obtained is then used to build a model to represent the device information by extracting tokens with similar probability and range from a larger language model (e.g., Wikipedia or other large collection of meaningful words) or performing other similar probabilistic analysis of the tokens. In one example, topic models, such as Latent Dirichlet Allocation (LDA), are useful tools for the statistical analysis of document collections. For example, LDA is generative probabilistic model as well as a “bag of words” model. In other words, the words or tokens extracted from text of the content information are assumed to be exchangeable within them. The LDA model assumes that the words of each document arise from a mixture of topics, each of which is a probability distribution over the vocabulary. As a consequence, LDA represents documents as vectors of word counts in a very high dimensional space, while ignoring the order in which the words or tokens appear. While it is important to retain the exact sequence of words for reading comprehension, the linguistically simplistic exchangeability assumption is essential to efficient algorithms for automatically eliciting the broad semantic themes in a collection of language token.

Another example of a modeling algorithm is the probabilistic latent semantic analysis (PLSA) model. PLSA is a statistical technique for analyzing two-mode and co-occurrence data. PLSA was evolved from latent semantic analysis, and added a sounder probabilistic model. PLSA has applications in information retrieval and filtering, natural language processing, machine learning from text, and related areas. Regardless of the model used, it is contemplated that the token parser 207 can generate the language tokens associated with a particular context (e.g., location, time, activity, etc.), application, or other criteria. The token parser 207 can then determine respective frequency counts of the determined tokens to create, for instance, one or more prioritized arrays of the tokens. In one embodiment, the tokens, frequency counts, prioritized arrays, and related information are stored in the token database 109.

In one embodiment, the token analysis module 203 can interact with the token customizer 209 to customize and/or facilitate the customization of at least one or more of the determined tokens. For example, the token customizer 209 can receive input directly from the user for adding, deleting, and/or modifying any of the tokens. In addition, the token customizer 209 can recommend whether to delete, modify, or add tokens based on analysis of the respective frequency counts of the tokens.

In addition, the token analysis module 203 can interact with the recommendation engine 211 to generate recommendation information based on the one or more tokens. The recommendation information, for instance, can be used by one or more applications 113 and/or content providers 115 to determine relevant functions, services, content, items, etc. to present to the user. In some embodiments, the recommendation engine 211 can also interact with the token parser 207 to translate or otherwise convert the tokens to a target or specified language, thereby enabling interoperability of the tokens among multiple languages. For example, device information and related tokens may come from, for instance, web pages, services 113, etc. in multiple languages even when operating within a particular region. In one embodiment, the token set may support explicit language definitions within regions but not all languages may be supported. In such cases, the token parser 207 can translate tokens from one language to another. In one embodiment, the translation can be performed after resolution of the tokens in one language (e.g., English or whatever the language may be predominant for a particular area).

From the perspective of applying the token set to generate recommendation information, the recommendation engine 211 interacts with an application programming interface 213 to receive requests for recommendations from, for instance, the application and/or services 113. In one embodiment, the request may include parameters such as context information (e.g., a set of one or more contexts) associated with the application 113 or UE 101 associated with the request. It is noted that these parameters are optional. In one embodiment, the default behavior in case no parameters are provided would be a temporal recommendation that is based on the most general token set.

In one embodiment, the control logic 201 and/or the token analysis module 203 can interact with the input module 215 to receive or otherwise act on incoming device information and then process the new device information via an input resolver 217. In this example, the input resolver 217 normalizes or maps input values or parameters to specific boundaries of the context parameters (depending on how context parameters are interpreted) that makes them easier to process via the applicable token sets.

In the example of FIG. 2, the input resolver 217 has connectivity to a location resolver 219, a time resolver 221, and other resolver 223. Although these three types of input resolvers are depicted, it is contemplated that the token management platform 103 may include any one or more of the input resolvers in any combination. In one embodiment, the location resolver 219 relies on an external location database (e.g., location database 208c). The location database 208c contains, for instance, border point definitions for places. The location resolver 219 is able to map a given coordinate within the border point definitions and to a specific place name within the database. The resolved place name form a given coordinate is then used for token determination and/or related frequency counts.

In another embodiment, a second database may be employed that maps a place name to a specific path in the token set (e.g., a path of nodes within the hierarchy). For example, the path can assist the token management platform 103 to speed up identification a resolved location for classification and/or indexing with one or more tokens. In one embodiment, the token sets can be based on location, and it is assumed that given a location, a specific token set can be identified for that location. In one embodiment, the raw location data is not used directly in the rule set, but is used in the location resolver 219 to identify a place name or a shortcut of the place name.

In one embodiment, the input resolver 217 also has connectivity to a time resolver 221. By way of example, the time resolver 221 resolves the given time relative to, for instance, the client device (e.g., the UE 101) to a given part of day. This process essentially maps a given time of day into one of enumerated part-of-day definitions for the token set. Table 1 provides examples of enumerated definitions and their corresponding boundaries.

TABLE 1

| Interval name | Boundary value |
|---|---|
| Early-morning | 4:00-7:59 |
| Morning | 8:00-9:59 |
| Late-morning | 10:00-11:59 |
| Noon | 12:00-12:59 |
| Afternoon | 13:00-15:59 |
| Evening | 16:00-17:59 |
| Late-evening | 18:00-19:59 |
| Night | 20:00-23:59 |
| Mid-night | 00:00-3:59 |

In embodiments where the token sets include or are based on other types of context parameters (e.g., an activity), the other resolver 223 can be used to establish the appropriate boundaries and resolve the context for classification and/or indexing against one or more tokens.

In one embodiment, following resolution of the input, the token analysis module interacts with the external module/plugin interface 225 to provide additional functionality, content, etc. based on the tokens associated with the input and/or other device information. For example, the external module/plugin interface 225 links the token management platform 103 to the service platform 111 and/or content provider 115. In one use case, the service platform 111 and/or content provider 115 may provide plugins to present advertisements, marketing information, promotions, etc. to the user based on the determine tokens. This information along with other information such as recommendation information, tokens, contexts, contact information, etc. are present via the output module 227.

In one embodiment, the output module 227 facilitates a creation and/or a modification of at least one device user interface element, at least one device user interface functionality, or a combination thereof based, at least in part, on information, data, messages, and/or signals resulting from any of the processes and or functions of the token management platform 103 and/or any of its components or modules. By way of example, a device user interface element can be a display window, a prompt, an icon, and/or any other discrete part of the user interface presented at, for instance, the UE 101. In addition, a device user interface functionality refers to any process, action, task, routine, etc. that supports or is triggered by one or more of the user interface elements. For example, user interface functionality may enable speech to text recognition, haptic feedback, and the like. Moreover, it is contemplated that the output module 227 can operate based at least in part on processes, steps, functions, actions, etc. taken locally (e.g., local with respect to a UE 101) or remotely (e.g., over another component of the communication network 105 or other means of connectivity).

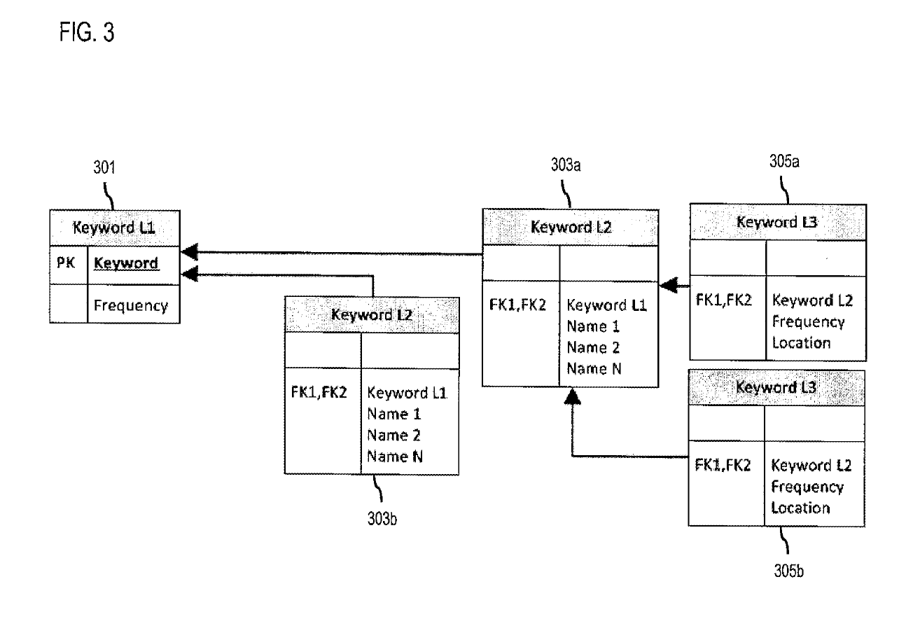

FIG. 3 is a diagram of data structure for storing tokens, according to one embodiment. In one embodiment, the token management platform 103 organizes the tokens into a hierarchy of categories and subcategories. In one embodiment, the token management platform 103 defines at least three levels of tokens by default: (1) the first root level 301 represents, for instance, a “Category” such as “shopping” or “messaging”; (2) the second level 303a and 303b represents a “Type” of the “Category”, e.g., if the “Category” is “shopping”, the types can be “Downloads”, “Bookstore”, “Mall”; (3) the third level 305a and 305b represents “Location”, e.g., if the “Category” is “shopping” and the “Type” is “downloading”, the location can be “manufacturer online store”. Each token can also be associated with a frequency count.

In one embodiment, the hierarchy of tokens can be created based on different granularities of the tokens. Typically, the least granular or broadest scope of the tokens is specified as the top or root level of the hierarchy with each subsequent child level of the hierarchy associated with a more granular division of the tokens. For example, if the token is a geographic location then the top level of the hierarchy represents the largest division of geographic scale (e.g., a global scale). Then, each subsequent level is defined with greater granularity (e.g., continent followed by country, then by state, etc.). Similarly, if the token is based on time, a top level might represent all time followed by finer granular segmentation of time (e.g., millennia followed by century, then by decade, year, etc.).

In certain embodiments, the one or more context parameters associated with the tokens may be combined to provide for more complex contexts. For example, location may be combined with time to generate the hierarchy. In this case, each location node may be further qualified or supplemented with time information. For instance, a context might specify a city with time broken out as morning, noon, afternoon, evening, night, etc. In this example, each permutation of city and time represents a separate node or context. It is contemplated that any number of context parameters may be combined to create contexts of varying complexity and intricacies.

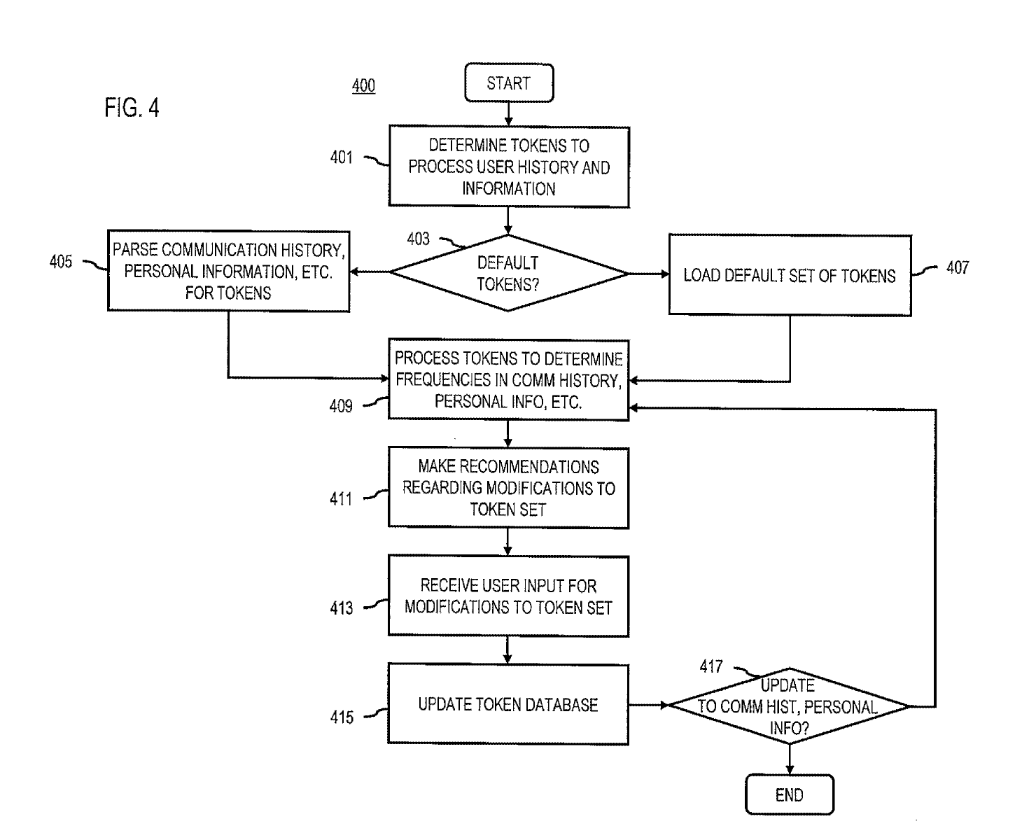

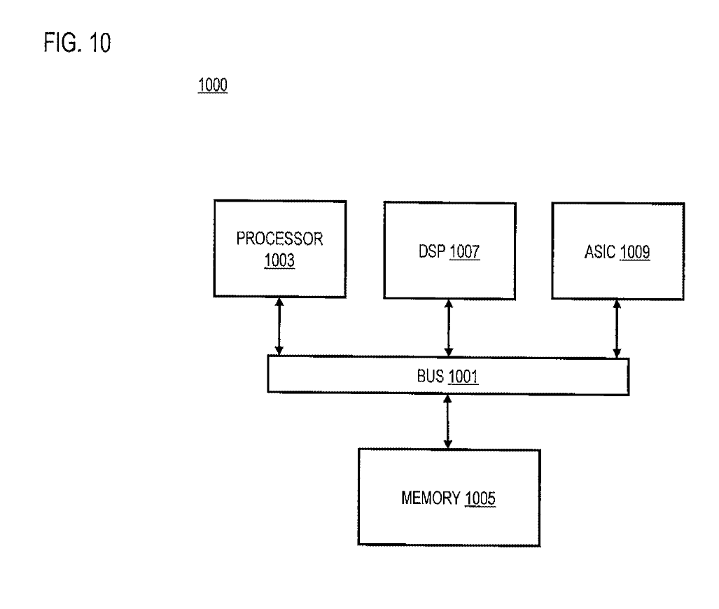

FIG. 4 is a flowchart of a process for initializing token-based classification of device information, according to one embodiment. In one embodiment, the token management platform 103 performs the process 400 and is implemented in, for instance, a chip set including a processor and a memory as shown in FIG. 10. In addition or alternatively, the token manager 107 may perform all or a portion of the process 400. In step 401, the token management platform 103 determines a plurality of tokens, the tokens including at least in part one or more keywords, one or more representative media items, or a combination thereof. In one embodiment, the tokens describe, at least in part, to one or more potential interests, one or more relationships, one or more relationship states, one or more states of mind, or a combination thereof. Next, the token management platform 103 determines whether to use a default set of tokens as a starting point (step 403).

If not, the token management platform 103 processes and/or facilitates a processing of the communication history, the one or more personal information sources, or a combination thereof according to a semantic analysis to determine the plurality of tokens (step 405). By way of example, the one or more personal information sources include, at least in part, one or more multimedia databases, one or more landmark databases, or a combination thereof. Otherwise, the token management platform 103 determines the plurality of tokens based, at least in part, on a default set of tokens which are loaded from the token database 109 (step 407).

At step 409, the token management platform 103 processes and/or facilitates a processing of a communication history, one or more personal information sources, or a combination thereof associated with a user to determine one or more frequency counts of respective one or more of the tokens. For example, if the communication history, personal information sources, etc. are text based, the token management platform 103 performs a parsing operation to determine the tokens and their respective frequency counts. If, for example, the communication history, personal information sources, etc. are multimedia files, the token management platform 103 can parse the metadata associated with the files or perform image recognition on the information to determine matching tokens. In some cases, multimedia files (e.g., music, video, etc.) can be parsed by filename and tag information (e.g., artist name, genre, etc.). Similarly, pictures or images can be parsed by the tag information (e.g., EXIF data and any associated location data or geo-tag data to indicate where the picture was taken). With respect to location, the user can set a threshold value for the token management platform 103 to determine whether any set of multiple coordinates represents the same place. For example, if the location data or coordinates are within 500 m away from a place or from each other, the token management platform 103 can treat the coordinates as coming from the same place.

In one embodiment, the token management platform 103 also determines context information associated with the user, wherein the processing of the communication history, the one or more personal information sources, or a combination thereof to determine the one or more frequency counts is further based, at least in part, on the one or more contacts. By way of example, the context information includes, at least in part, location information, time information, activity information, or a combination thereof.

In some embodiments, the token management platform 103 can also suggest that some tokens or category of tokens should be removed if they are not frequently used or not used at all with respect to the device information (step 411). It is also contemplated that the token management platform 103 may make any other recommendations regarding modifications to the determined token set. In response, the token management platform 103 receives an input, from the user, for adding, deleting, and/or modifying one or more of the tokens to create a customized set of the tokens (step 413). Based on the modification, the token management platform 103 updates the token database 109 (step 415). In one embodiment, the token management platform 103 determines to cause, at least in part, a sharing of the customized set of the tokens with one or more other users.

At step 417, the token management platform 103 determines at least one update to the communication history, the one or more personal information sources, or a combination thereof, and then processes and/or facilitates a processing of the at least one update to update the one or more frequency counts, the tokens, or a combination thereof.

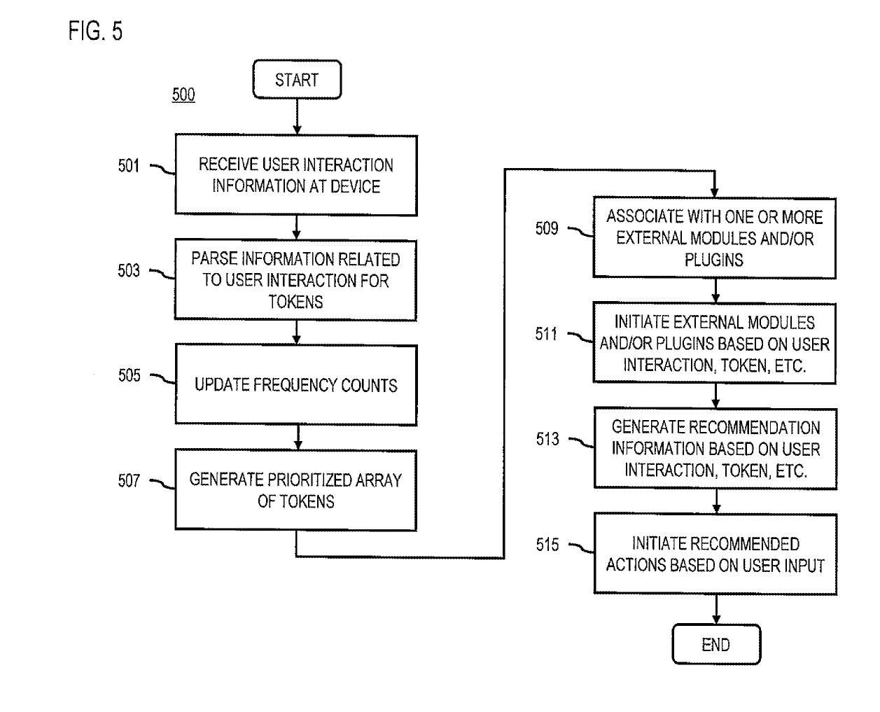

FIG. 5 is a flowchart of a process for generating recommendation information from token-based classification of device information, according to one embodiment. In one embodiment, the token management platform 103 performs the process 500 and is implemented in, for instance, a chip set including a processor and a memory as shown in FIG. 10. In addition or alternatively, the token manager 107 may perform all or a portion of the process 500. In step 501, the token management platform 103 determines interaction information at a device associated with the user. For example, the interaction information may include receiving incoming device information (e.g., messages, downloads, search history, etc.). The token management platform 103 can then parse information related to the user interaction for one or more of the determined tokens to determine whether the interaction relates to one or more of the tokens (step 503).

If the interaction relates to the one or more tokens, the token management platform 103 processes and/or facilitates a processing of the interaction information to update the one or more frequency counts, the tokens, or a combination thereof (step 505). Based, at least in part, on the tokens and associated frequency counts, the token management platform 103 generates a prioritized array of most relevant tokens (e.g., most frequently occurring tokens) (step 507). It is contemplated that the prioritized array may contain a predetermined number of the tokens that comprise a subset of the tokens contained within the token database 109.

In some embodiments, the token management platform 103 determines to associate one or more action modules, one or more information modules, or a combination thereof with one or more of the tokens (step 509). By way of example, the one or more action modules, the one or more information modules, or a combination thereof relate, at least in part, to advertising, marketing, promotions, or a combination thereof. The token management platform 103 can then initiate the associated external modules and/or plugins based, at least in part, on the user interaction, determined tokens, frequency counts, and the like (step 511). For example, if a token matches or substantially matches an advertising plugin, the corresponding advertisement may be presented to the user.

In addition, the token management platform 103 determines to cause, at least in part, a generation of recommendation information based, at least in part, on the one or more frequency counts of the respective one or more tokens (step 513). As discussed earlier, the recommendation information may be associated with or requested by one or more applications executing at the UE 101. The token management platform 103 can receive user input with respect to the recommendations and initiate any corresponding recommended actions accordingly (step 515).

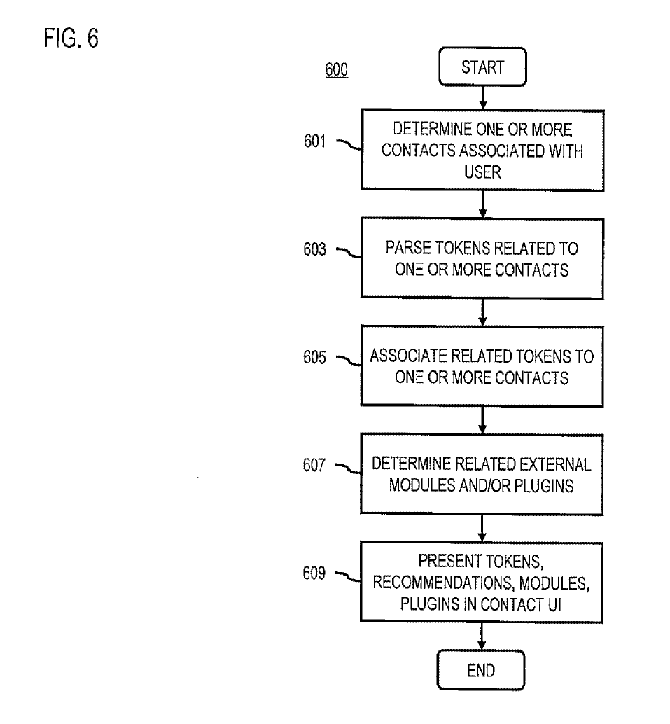

FIG. 6 is a flowchart of a process for applying token-based classification to contact information, according to one embodiment. In one embodiment, the token management platform 103 performs the process 600 and is implemented in, for instance, a chip set including a processor and a memory as shown in FIG. 10. In addition or alternatively, the token manager 107 may perform all or a portion of the process 600. The process 600 discusses one use case for various embodiments of the token-based classification processes described herein to characterize interests or information associated with one or more contacts of a user. In step 601, the token management platform 103 determine one or more contacts associated with the user, wherein the processing of the communication history, the one or more personal information sources, or a combination thereof to determine the one or more frequency counts is further based, at least in part, on the one or more contacts.

More specifically, the token management platform 103 parses the device information that are related to the contact (e.g., messages to or from a contact, information about a contact, images of the contact, etc.) to determine one or more prevalent tokens from the set of tokens stored in the token database 109 (step 603). The token management platform 103 then determines to associate one or more of the tokens with the one or more contacts based, at least in part, on the one or more frequency counts (step 605). As previously noted, the tokens describe, at least in part, to one or more potential interests, one or more relationships, one or more relationship states, one or more states of mind, or a combination thereof. In other words, the tokens can also represent the mood or feeling of a relationship between the user and a particular contact.

In certain embodiments, the token management platform 103 may also determine whether there are any external modules/plugins (e.g., advertisement plugins) that are related or otherwise relevant to the contact based, at least in part, on the associated tokens. The token management platform 103 then causes, at least in part, presentation of the one or more associated tokens, the recommendation information, or a combination thereof in a user interface based, at least in part, on the one or more contacts (step 609). In some embodiment, the token management platform 103 determines to organize the plurality of tokens into a hierarchy of categories and one or more subcategories. In this case, the token management platform 103 can also present the one or more associated tokens, the recommendation information, or a combination thereof in the user interface based, at least in part, on the hierarchy

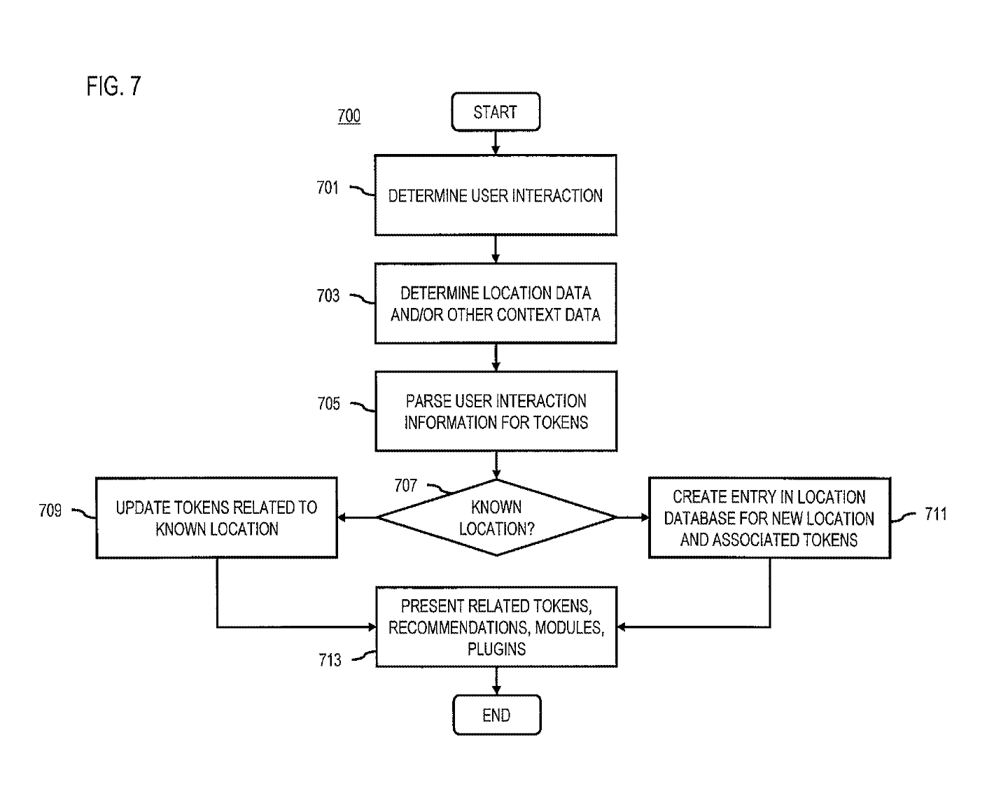

FIG. 7 is a flowchart of a process for applying token-based classification to location data, according to one embodiment. In one embodiment, the token management platform 103 performs the process 700 and is implemented in, for instance, a chip set including a processor and a memory as shown in FIG. 10. In addition or alternatively, the token manager 107 may perform all or a portion of the process 700. The process 700 discusses a use case for classifying locations and places based on tokens. For example, when a user enters a place or initiates a user interaction associated with location data, the tokens associated with the place or location can be processed. In step 701, the token management platform 103 determines or otherwise detects a user interaction at a device (e.g., entering a location, sending a message about a location, etc.).

The token management platform 103 then determines location data and/or other context data associated with the user interaction (step 703). If the user interaction is associated with location data, the token management platform 103 parses the information related to the user interaction for one or more tokens (step 705). The token management platform 103 then determines whether the location data corresponds to a known location (e.g., is the location or place stored in the location database 208c) (step 707).

If the location is previously known or has been previously recorded, the token management platform 103 enables the user to update tokens related to or previously stored for the known location (step 709). For example, the user can determine the tokens which can represent the location or place. Also, the tokens and/or the corresponding location database 208c can be updated automatically by the UE 101 of the user by retrieving new information and/or messages regarding the place over, for instance, a short range wireless connection (e.g., Bluetooth) or over the communication network 105. In this way, the location database 208c can be kept up to date.

If the location is not known, the token management platform 103 can create a new entry in the location database 208c to store the location and associated tokens (step 711). For example, the entry can include the coordinates of the location, one or more tokens, respective frequency counts of the tokens with respect to the location, a shortcut name for the location (e.g., Home, Work, etc.). The token management platform 103 can then present the determined or related tokens, any recommendations, external modules/plugins (e.g., advertisement plugins), etc. associated with the place (step 713).

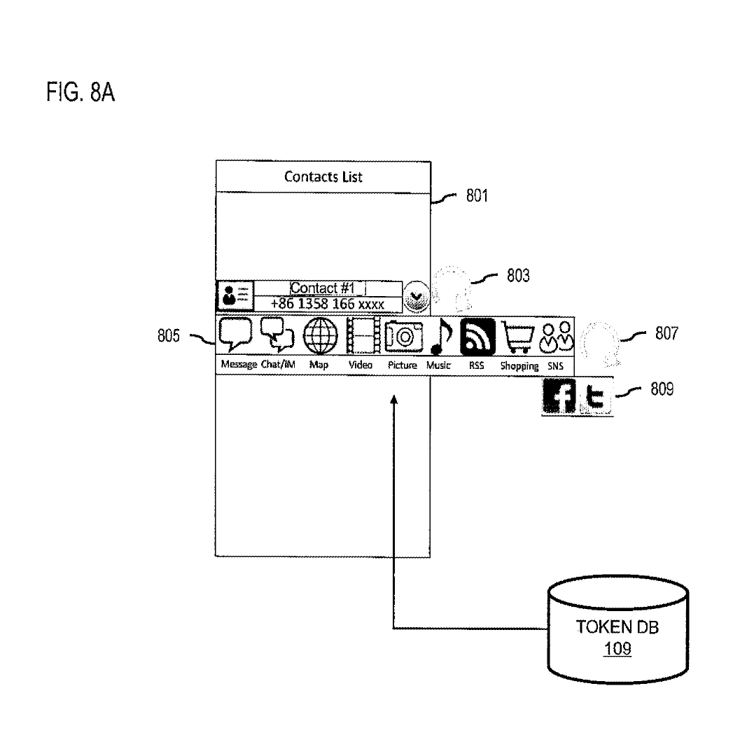

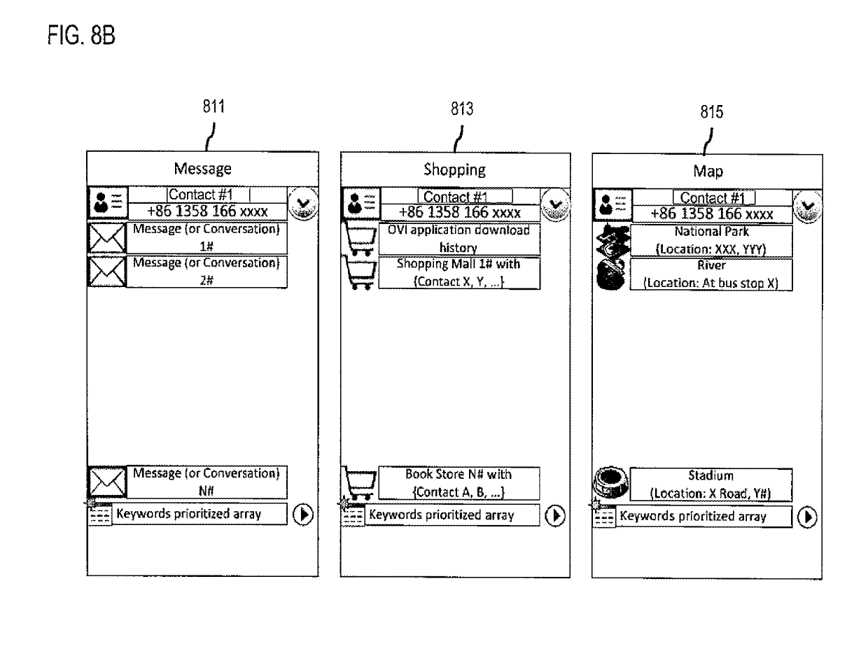

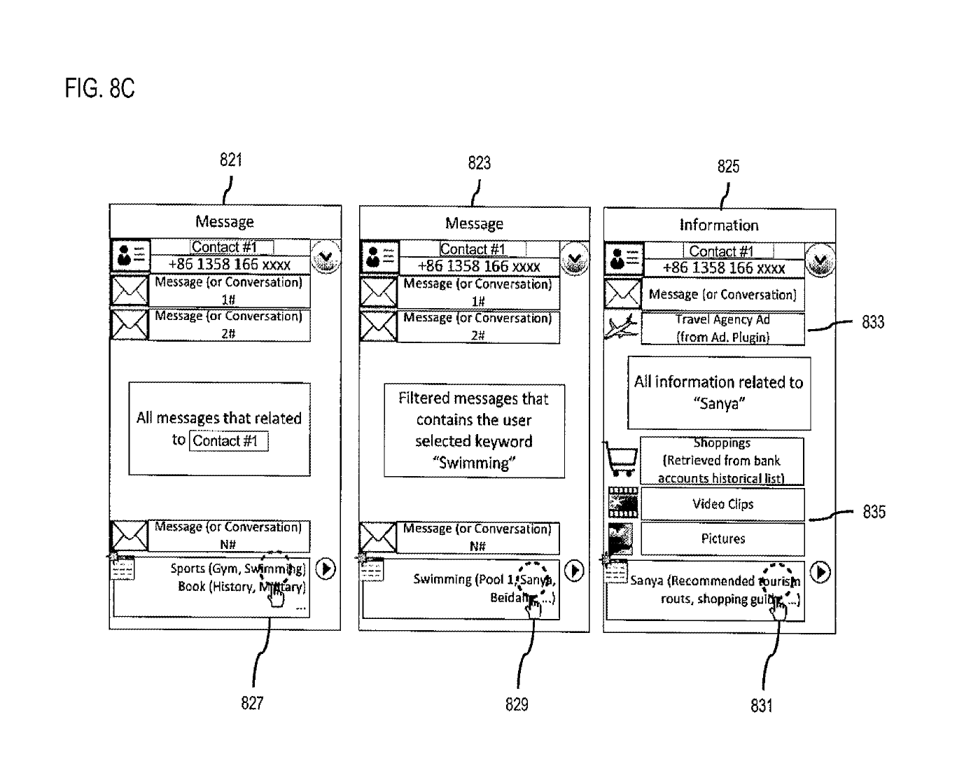

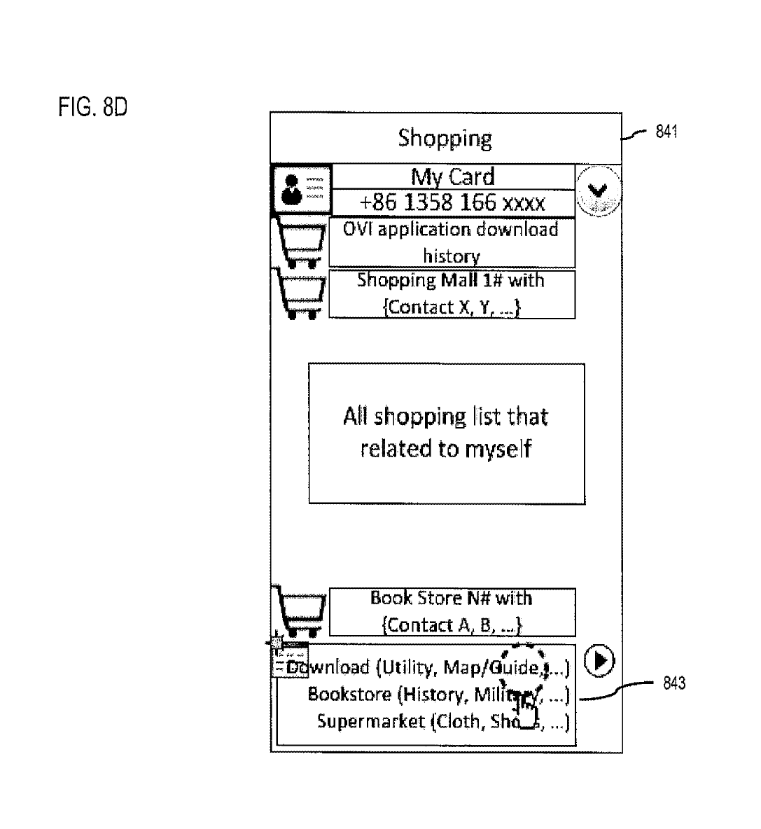

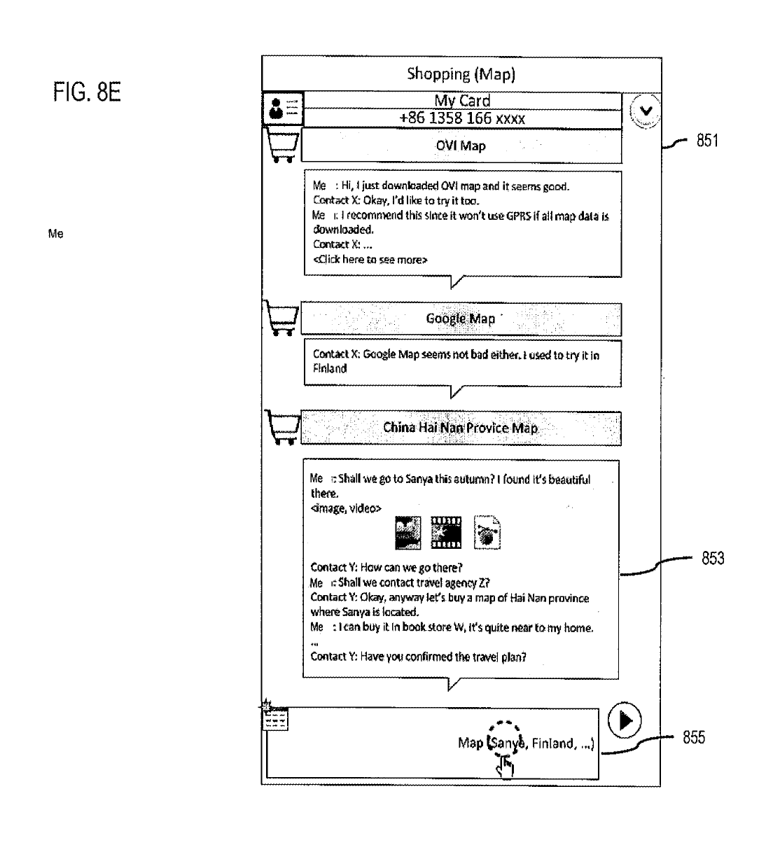

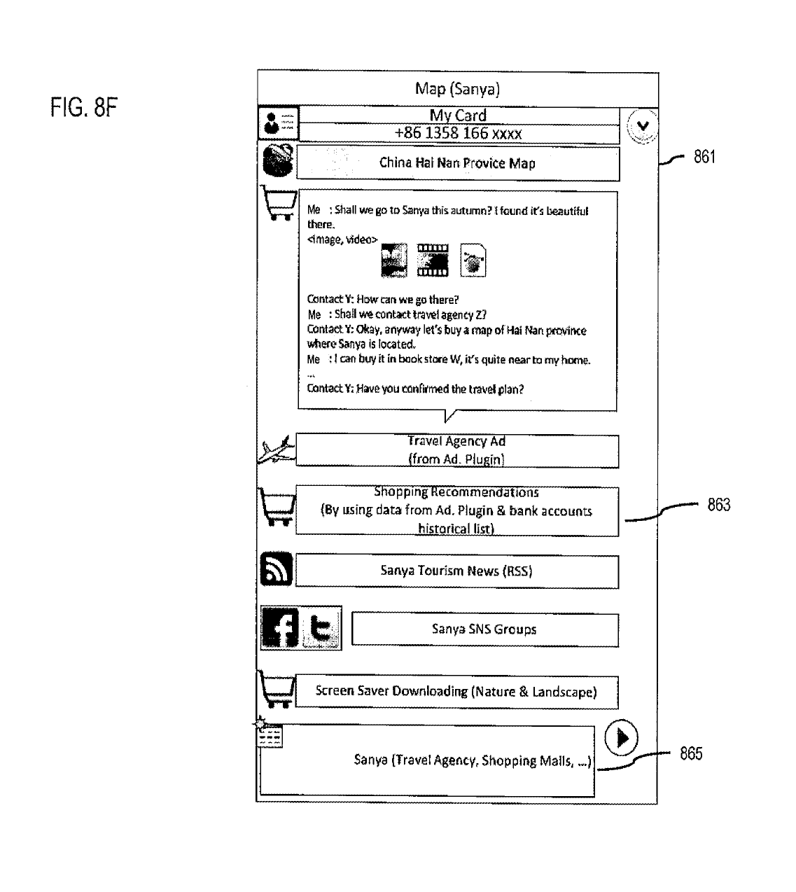

FIGS. 8A-8F are diagrams of user interfaces used in the processes of FIGS. 1-7, according to various embodiments. In the examples FIGS. 8A-8F, the depicted user interfaces (UIs) include one or more user interface elements and/or functionalities created and/or modified based, at least in part, on information, data, and/or signals resulting from any of the processes described with respect to FIGS. 1-7.

More specifically, a UI 801 of FIG. 8A depicts a user interface that presents contact information associated with a “Contact #1” along with the tokens with the highest frequency counts based, at least in part, on an analysis of the user's device information. In this example, the user can make a selection 803 to display the token list 805. The display order of the token list 805 (both Category and Type of the token hierarchy) is prioritized by frequency counts as stored in the token database 109. This token list 805 also is dynamically created and can be adjusted by the user manually. In this example, the user further makes a further selection 807 of the social networking service (SNS) token to display the most frequently counted social networking services 809 (e.g., Facebook® and Twitter®).

The UIs 811-815 of FIG. 8B depict user interfaces for presenting information hubs specific to different categories of tokens with respect to a “Contact #1”. For example, UI 811 presents device information related to a token “Message”. Accordingly, the UI lists all messages associated with the Contact #1. The UI 811 also presents a prioritized array of keywords determined from Contact #1's messages. The UI 813 presents device information and tokens related to the token “Shopping” with an accompanying history of shopping activities conducted by Contact #1. Similarly, the UI 815 presents device information and tokens related to the token “Map” with an accompanying history of locations visited by Contact #1. It is contemplated that an information hub UI can be used to display any token and associated data in a similar format.

The UIs 821-825 of FIG. 8C depict user interfaces for receiving recommendation information based on selected tokens. In this example, the user is browsing a contact (e.g., Contact #1) to discover information regarding a specific location. The UI 821 depicts a contact entry for “Contact #1” that lists all messages associated with the contact. The token management platform 103 presents a list of tokens most representative of the collection of messages. In this case, the tokens of interest are “Sports” with subcategories of “Gym” and “Swimming”, and “Book” with subcategories of “History” and “Military”. As shown, the user makes a selection 827 of “Swimming” to discover more information and related tokens. Accordingly, in the UI 823 the message list has now been filtered to shown only those messages related to the token “Swimming”. In addition, the next level of tokens associated with “Swimming” is presented. This next level presents tokens related to possible locations associated with “Swimming”. In this example, the user makes a selection 829 of “Sanya”, a swimming resort. The selection 829 results in presentation of the UI 825 which filters the messages of Contact #1 further to only those messages related to “Sanya”. In the UI 825, the token management platform 103 displays a list of recommended tokens associated with “Sanya”. The user makes a selection 831 of tourism with respect to Sanya. In response, the UI 825 accesses an advertising plugin to present travel advertisement 833 related to Sanya as well as other indexed information 835 (e.g., prior purchases, media files) from the user's device that is related to Sanya.

FIGS. 8D-8F present user interfaces for browsing by category. In the examples of FIGS. 8D-8F, the user has selected to browse all information related to shopping. More specifically, the UI 841 of FIG. 8D shows that the user has selected to browse generally without limiting the browsing to a specific contact by selecting to browse using “My Card”. In this case, “My Card” provides all information related to the user. Accordingly, the UI 841 displays all of the user's shopping information available at the UE 101. The token management platform 103 also presents a list of tokens associated with the shopping category. In this example, the user makes a selection 843 to browse information related to the “Map/Guide” token. Based, on the selection 843, the token management platform 103 presents the UI 851 that presents shopping related activities and messages concerning maps. On message entry 853 reminds the user that he/she intended to “Sanya” in the fall, which prompts the user to make a further selection 855 of the token “Sanya”.

Then based on the selection 855, the token management platform 103 presents the UI 861 that further narrows the presented information to information related to Sanya. In addition, the token management platform 103 display recommendations 863 related to external modules/plugins for advertising recommendations, shopping recommendations, suggested news feeds, recommended social networking groups, and file downloads. The UI 861 also presents a more detailed level of tokens 865 for further selection by the user.

The processes described herein for providing token-based classification of device information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

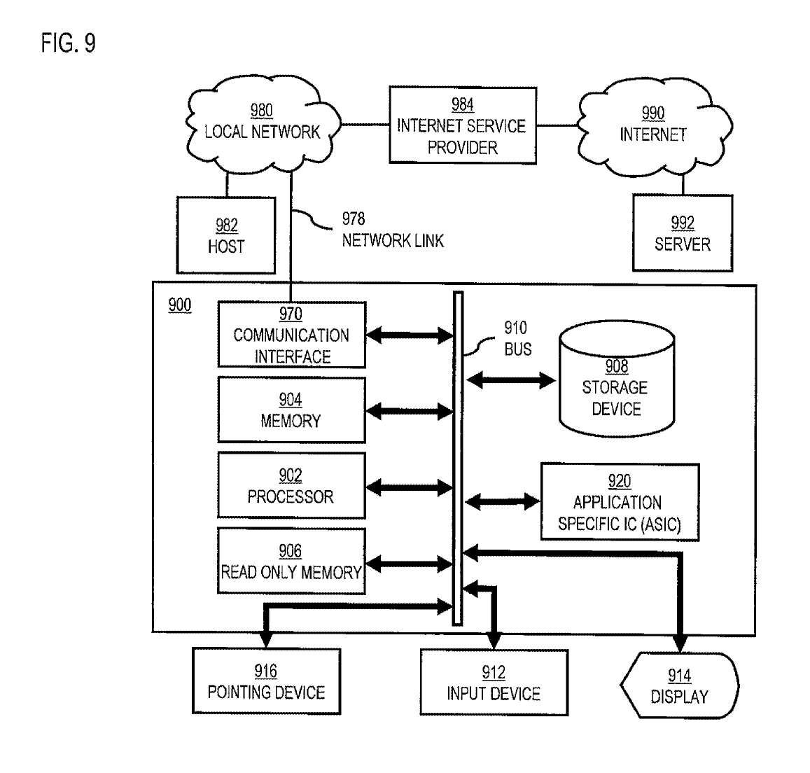

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide token-based classification of device information as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing token-based classification of device information.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing token-based classification of device information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing token-based classification of device information. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing token-based classification of device information, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing token-based classification of device information.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide token-based classification of device information as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing token-based classification of device information.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide token-based classification of device information. The memory 1005 also stores the data associated with or generated by the execution of the inventive steps.

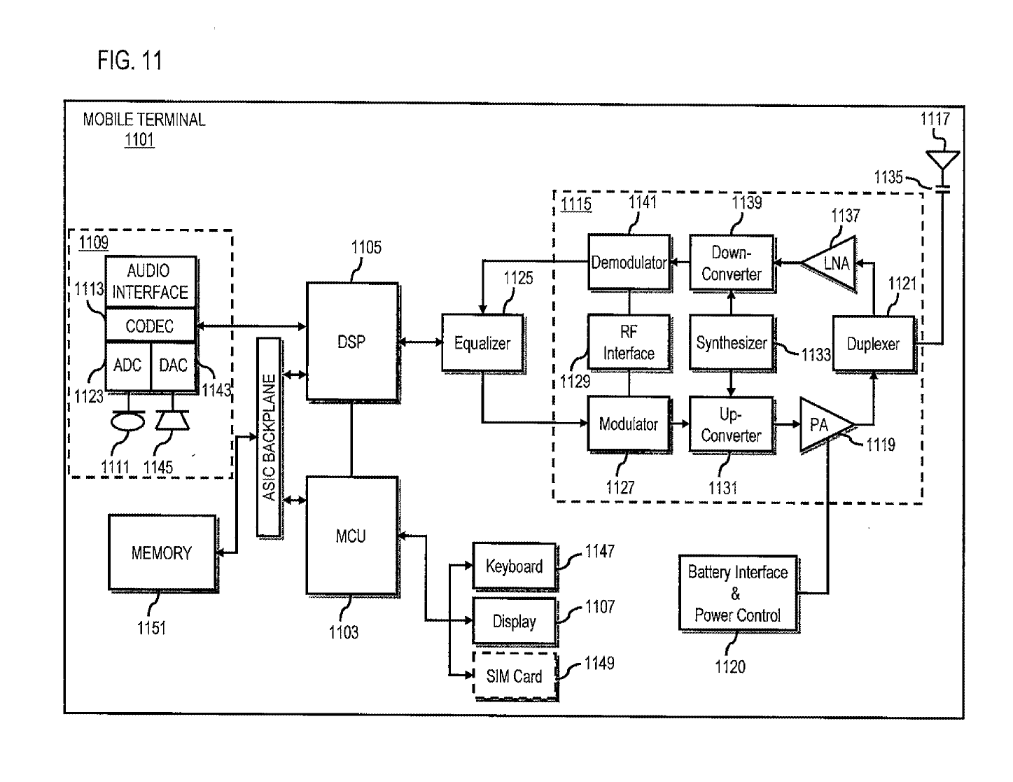

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing token-based classification of device information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing token-based classification of device information. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide token-based classification of device information. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a set of tokens, wherein the set of tokens are pre-determined to represent things, ideas, concepts, categories, or a combination thereof of potential interest to a user;
initiating a classification or an indexing of device information associated with the user
according to the set of tokens, wherein the device information is information stored at or otherwise associated with a device of the user;
prioritizing the set of tokens for the user based on the classification or the indexing; and
generating one or more recommendations of the things, ideas, concepts, categories, or combination thereof of potential interest to the user based on the prioritized set of tokens.

2. The method of claim 1, further comprising:
processing a communication history between the user and one or more contacts to classify or to index the communication history based on the set of tokens,
wherein the prioritized set of tokens is further based on the classified or indexed communication history between the user and the one or more contacts to personalize the prioritized set of tokens to the one or more contacts.

3. The method of claim 2, wherein the one or more recommendations are generated with respect to the one or more contacts based on the personalized and prioritized set of tokens.

4. The method of claim 1, further comprising:
parsing the device information associated with a user by using a semantic analysis to determine the set of tokens.

5. The method of claim 1, wherein the set of tokens is associated with one or more contextual parameters, the method further comprising:
resolving a context of the device according to the one or more contextual parameters to select the set of tokens.

6. The method of claim 5, wherein the one or more contextual parameters include a location, a time interval, an activity, or a combination thereof.

7. The method of claim 1, wherein the set of tokens is organized according to a hierarchy, and wherein the hierarchy includes a first level representing of a category, a second level representing of a type of the category, and a third level representing a location.

8. The method of claim 1, further comprising:
presenting device information at the device based on the classification or the indexing, and based on a selected one of the set of tokens.

9. The method of claim 1, wherein the device information includes communication histories, pictures, personal information databases, multimedia databases, application data, browsing histories, or a combination thereof previously stored on the device by the user, and wherein the prioritizing of the set of tokens is based on determining a number of times each token of the set of tokens appears in the communication histories, pictures, personal information databases, multimedia databases, application data, browsing histories, or a combination thereof.

10. The method of claim 1, wherein the one or more recommendations include one or more recommended external modules or plugins to install at the device.

11. An apparatus comprising:
at least one processor; and
at least one memory including computer program code for one or more programs,
the at least one memory and the computer program code configured to, with the at least one processor, cause the apparatus to perform at least the following,
determine a set of tokens, wherein the set of tokens are pre-determined to represent things, ideas, concepts, categories, or a combination thereof of potential interest to a user;
initiate a classification or an indexing of device information associated with the user according to the set of tokens, wherein the device information is information stored at or otherwise associated with a device of the user;
prioritize the set of tokens for the user based on the classification or the indexing; and
generate one or more recommendations of the things, ideas, concepts, categories, or combination thereof of potential interest to the user based on the prioritized set of tokens.

12. The apparatus of claim 11, wherein the apparatus is further caused to:
processing a communication history between the user and one or more contacts to classify or to index the communication history based on the set of tokens,
wherein the prioritized set of tokens is further based on the classified or indexed communication history between the user and the one or more contacts to personalize the prioritized set of tokens to the one or more contacts.

13. The apparatus of claim 11, wherein the apparatus is further caused to:
parsing the device information associated with a user by using a semantic analysis to determine the set of tokens.

14. The apparatus of claim 11, wherein the set of tokens is associated with one or more contextual parameters, and wherein the apparatus is further caused to:
resolving a context of the device according to the one or more contextual parameters to select the set of tokens.

15. The apparatus of claim 11, wherein the device information includes communication histories, pictures, personal information databases, multimedia databases, application data, browsing histories, or a combination thereof previously stored on the device by the user, and wherein the prioritizing of the set of tokens is based on determining a number of times each token of the set of tokens appears in the communication histories, pictures, personal information databases, multimedia databases, application data, browsing histories, or a combination thereof.

16. A non-transitory computer-readable storage medium for generating parking occupancy data using a machine learning model, carrying one or more sequences of one or more instructions which, when executed by one or more processors, cause an apparatus to at least perform the following steps:
determining a set of tokens, wherein the set of tokens are pre-determined to represent things, ideas, concepts, categories, or a combination thereof of potential interest to a user;
initiating a classification or an indexing of device information associated with the user according to the set of tokens, wherein the device information is information stored at or otherwise associated with a device of the user;
prioritizing the set of tokens for the user based on the classification or the indexing; and
generating one or more recommendations of the things, ideas, concepts, categories, or combination thereof of potential interest to the user based on the prioritized set of tokens.

17. The non-transitory computer-readable storage medium of claim 16, wherein the apparatus is further caused to:
processing a communication history between the user and one or more contacts to classify or to index the communication history based on the set of tokens,
wherein the prioritized set of tokens is further based on the classified or indexed communication history between the user and the one or more contacts to personalize the prioritized set of tokens to the one or more contacts.

18. The non-transitory computer-readable storage medium of claim 16, wherein the apparatus is further caused to:
parsing the device information associated with a user by using a semantic analysis to determine the set of tokens.

19. The non-transitory computer-readable storage medium of claim 16, wherein the set of tokens is associated with one or more contextual parameters, and wherein the apparatus is further caused to:
resolving a context of the device according to the one or more contextual parameters to select the set of tokens.

20. The non-transitory computer-readable storage medium of claim 16, wherein the device information includes communication histories, pictures, personal information databases, multimedia databases, application data, browsing histories, or a combination thereof previously stored on the device by the user, and wherein the prioritizing of the set of tokens is based on determining a number of times each token of the set of tokens appears in the communication histories, pictures, personal information databases, multimedia databases, application data, browsing histories, or a combination thereof.
